(19) United States
(12) Patent Application Publication
(10) Pub. No.: US 2008/0080895 A1
(43) Pub. Date: Apr. 3, 2008

(54) PHOTOCONDUCTOR OF ELECTROPHOTOGRAPHIC IMAGE FORMING APPARATUS WITH SHORT WAVELENGTH LIGHT SOURCE AND ELECTROPHOTOGRAPHIC IMAGE FORMING APPARATUS USING THE SAME

(75) Inventors: Beom-jun KIM, Yongin-si (KR); Ji-young Lee, Suwon-si (KR); Saburo Yokota, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/684,260

(22) Filed: Mar. 9, 2007

(30) Foreign Application Priority Data
Sep. 28, 2006 (KR) 2006-94558

(51) Int. Cl. G03G 17/04

(52) U.S. Cl. 399/131; 430/69

(57) ABSTRACT

A photoconductor which can be effectively used in an electrophotographic image forming apparatus using a light source emitting short-wavelength light, and an electrophotographic image forming apparatus using the photoconductor. The photoconductor of the electrophotographic image forming apparatus using a short-wavelength light source includes a supporter and a photoconductive layer, which is formed on the supporter, wherein the photoconductive layer may include a naphthalenetetracarboxylic acid diimide derivative represented by the following Formula (I),

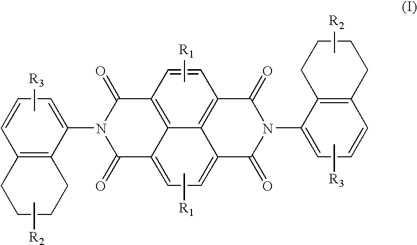

in which, R₁, R₂, and R₃ are each independently selected from the group consisting of a hydrogen atom, a halogen atom, a substituted or unsubstituted C₁ to C₂₀ alkyl group, a substituted or unsubstituted C₁ to C₂₀ alkoxy group, a substituted or unsubstituted C₆ to C₃₀ aryl group, and a substituted or unsubstituted C₇ to C₃₀ aralkyl group.

### CROSS-REFERENCE TO RELATED APPLICATIONS

This application claims priority under 35 U.S.C. §119 (a) of Korean Patent Application No. 10-2006-0094558, filed on Sep. 28, 2006, in the Korean Intellectual Property Office, the disclosure of which is hereby incorporated in its entirety by reference.

### BACKGROUND OF THE INVENTION

1. Field of the Invention

The present general inventive concept relates to a photoconductor of an electrophotographic image forming apparatus and an electrophotographic image forming apparatus using the photoconductor. More particularly, the present general inventive fconcept relates to a photoconductor which can be effectively used in an electrophotographic image forming apparatus using a light source emitting short-wavelength light, and an electrophotographic image forming apparatus using the photoconductor.

2. Description of the Related Art

An electrophotographic image forming apparatus forms a latent image on a photoconductor using a laser scanning device, and receives toner from a developer including a toner composition and develops the toner to form an image.

Hereinafter, a general operation for forming an image in an electrophotographic image forming apparatus will be described with reference to FIG. 1.

FIG. 1 is a schematic view of an image forming apparatus 1.

A photoconductor 11 is charged by a charging roller 16, a laser scanning unit (LSU) 18 forms an electrostatic latent image of an image to be developed, on the charged photoconductor 11. Atoner 14 in a developer is supplied to a developing roller 12 from a supplying roller 13. The toner supplied to the developing roller 12 is uniformly thinned by a toner layer regulating device 15, and at the same time is charged with high friction by the interaction between the developing roller 12 and toner layer regulating device 15.

When the toner passing through the toner layer regulating device 15 comes into contact with the photoconductor 11, the toner is developed on the latent image formed on the photoconductor 11. The developed toner is transferred to a printing sheet by a transferring roller 19, and completely fused onto the printing sheet, to form a final image.

If the toner developed on the photoconductor 11 remains on the photoconductor 11 after printing, a cleaning blade 17 removes the toner. The toner removed from the photoconductor 11 by the cleaning blade 17 is collected separately, classified, and discarded.

The LSU 18 includes a light source irradiating a laser beam, a collimating lens which collimates the laser beam irradiated from the light source, and an F-Theta lens which focuses the laser beam on the photoconductor 11. The photoconductor 11 includes a photoconductive layer for forming a latent image when the laser beam is irradiated from the LSU 18, and a supporter for supporting the photoconductor.

Aluminum gallium arsenide (AlGaAs) semiconductor lasers have generally been used as the light source of the LSU 18. AlGaAs have a basic oscillation wavelength of approximately 780 nm.

A blue semiconductor laser diode or a light emitting diode (LED) has recently been developed to be commercially available in an image forming apparatus. In order to increase the resolution of the image forming apparatus, it is necessary to reduce the spot size of the beam irradiated from the LSU 18. The spot size of the beam is proportional to the focal distance between the collimate lenses, and the wavelength of the laser beam, but is inversely proportional to the diameter of the lens. Accordingly, all conditions being equal, it is desirable to use the short-wavelength light source taking into consideration the resolution.

Therefore, in order to use the short-wavelength light source, a photoconductor using a material which has low light absorbance in a short-wavelength region is required.

### SUMMARY OF THE INVENTION

The present general inventive concept provides a photoconductor which can be effectively used in an electrophotographic image forming apparatus using a light source emitting short-wavelength light, and an electrophotographic image forming apparatus using the photoconductor.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a photoconductor of an electrophotographic image forming apparatus using a short-wavelength light source, including a supporter and a photoconductive layer, which is formed on the supporter. The photoconductive layer may include a naphthalenetetracarboxylic acid diimide derivative represented by the following Formula (I),

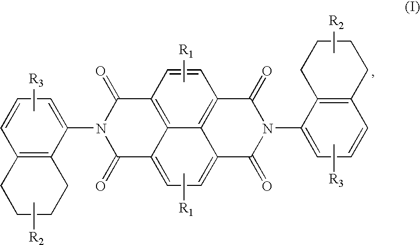

in which, R₁, R₂, and R₃ are each independently selected from the group consisting of a hydrogen atom, a halogen atom, a substituted or unsubstituted C₁ to C₂₀ alkyl group, a substituted or unsubstituted C₁ to C₂₀ alkoxy group, a substituted or unsubstituted C₆ to C₃₀ aryl group, and a substituted or unsubstituted C₇ to C₃₀ aralkyl group.

The light of the short-wavelength light source may have a wavelength of approximately 400 nm to approximately 500 nm.

The naphthalenetetracarboxylic acid diimide derivative may be any one of the compounds represented by the following Formulae (II) to (VIII),

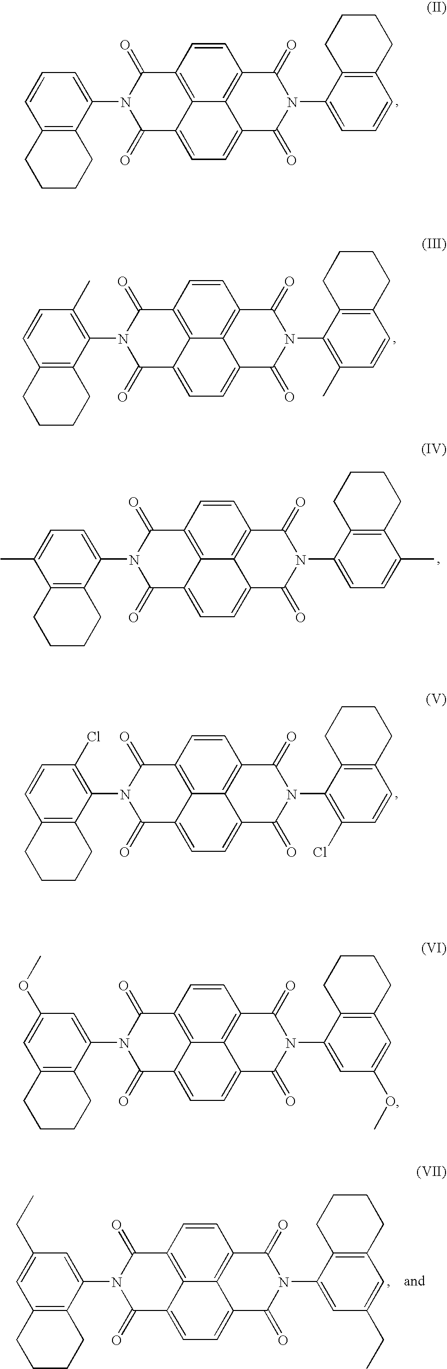

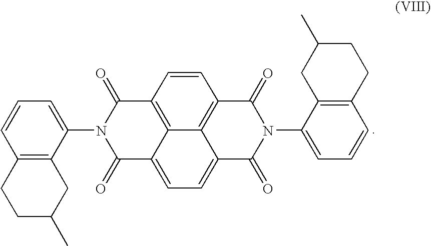

The photoconductive layer may further include a charge generating material and a hole transporting material.

The charge generating material may be titanyl oxyphthalocyanine, as represented by the following Formula (IX),

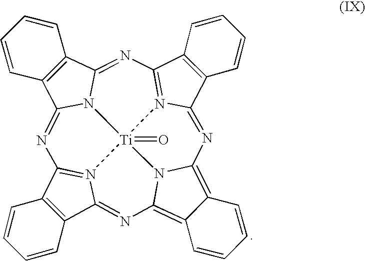

The hole transporting material may be a compound represented by the following Formula (X),

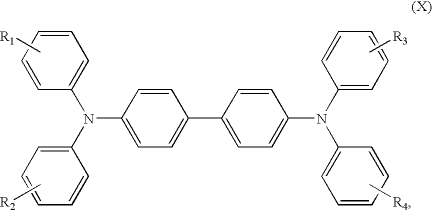

in which, R₁, R₂, R₃, and R₄ are each independently selected from a group consisting of a hydrogen atom, a halogen atom, a substituted or unsubstituted C₁ to C₂₀ alkyl group, a substituted or unsubstituted C₁ to C₂₀ alkoxy group, a substituted or unsubstituted C₆ to C₃₀ aryl group, and a substituted or unsubstituted C₇ to C₃₀ aralkyl group.

The hole transporting material may be a compound represented by the following Formula (XI),

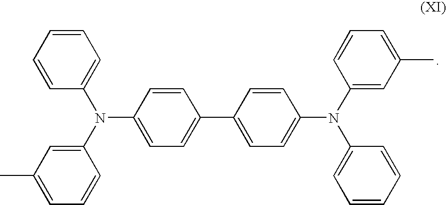

The hole transporting material may be a compound represented by the following Formula (XII),

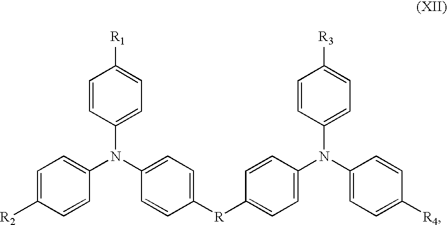

in which, R₁, R₂, R₃, and R₄ are each independently selected from the group consisting of a hydrogen atom, a halogen atom, a substituted or unsubstituted C₁ to C₂₀ cycloalkyl group, a substituted or unsubstituted C₁ to C₂₀ alkyl group, a substituted or unsubstituted C₁ to C₂₀ alkoxy group, a substituted or unsubstituted C₆ to C₃₀ aryl group, and a substituted or unsubstituted C₇ to C₃₀ aralkyl group.

The hole transporting material may be a compound represented by the following Formula (XIII),

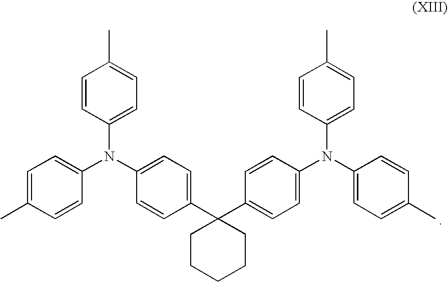

The foregoing and/or other aspects and utilities of the present general inventive concept may also achieved by providing an electrophotographic image forming apparatus employing a photoconductor and using a short-wavelength light source. The photoconductor may include a supporter, and a photoconductive layer which is formed on the supporter. The photoconductive layer may include a naphthalenetetracarboxylic acid diimide derivative represented by the following Formula (I),

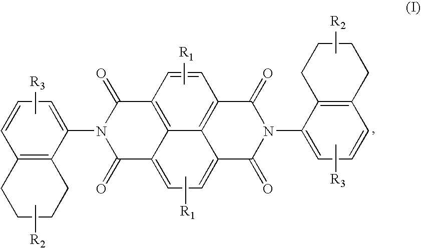

in which, R₁, R₂, and R₃ are each independently selected from the group consisting of a hydrogen atom, a halogen atom, a substituted or unsubstituted C₁ to C₂₀ alkyl group, a substituted or unsubstituted C₁ to C₂₀ alkoxy group, a substituted or unsubstituted C₆ to C₃₀ aryl group, and a substituted or unsubstituted C₇ to C₃₀ aralkyl group.

The light of the short-wavelength light source used in the electrophotographic image forming apparatus may have a wavelength of approximately 400 nm to approximately 500 nm.

The foregoing and/or other aspects and utilities of the present general inventive concept may also achieved by providing an electrophotographic image forming apparatus including a photoconductor including a supporter, and a photoconductive layer formed on the supporter, wherein the photoconductive layer includes a naphthalenetetracarboxylic acid diimide derivative represented by the following Formula (I),

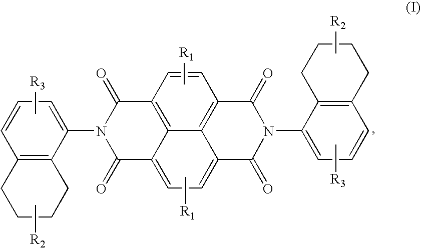

in which, R₁, R₂, and R₃ are each independently selected from the group consisting of a hydrogen atom, a halogen atom, a substituted or unsubstituted C₁ to C₂₀ alkyl group, a substituted or unsubstituted C₁ to C₂₀ alkoxy group, a substituted or unsubstituted C₆ to C₃₀ aryl group, and a substituted or unsubstituted C₇ to C₃₀ aralkyl group, and a short-wavelength light source to form an electrostatic latent image on the photoconductor, wherein the short-wavelength light source has a wavelength of approximately 400 nm to approximately 500 nm.

The foregoing and/or other aspects and utilities of the present general inventive concept may also achieved by providing a photoconductor including a supporter, and a photoconductive layer formed on the supporter, the photoconductive layer including binder resin, a charge generating material (CGM), a hole transporting material (HTM), and an electron transporting material (ETM) including a naphthalenetetracarboxylic acid diimide derivative represented by the following Formula (I),

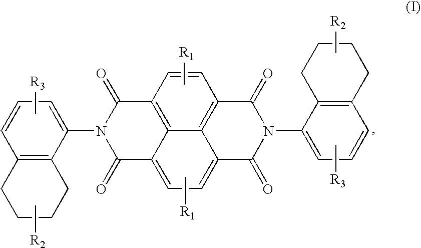

in which, R₁, R₂, and R₃ are each independently selected from the group consisting of a hydrogen atom, a halogen atom, a substituted or unsubstituted C₁ to C₂₀ alkyl group, a substituted or unsubstituted C₁ to C₂₀ alkoxy group, a substituted or unsubstituted C₆ to C₃₀ aryl group, and a substituted or unsubstituted C₇ to C₃₀ aralkyl group.

The foregoing and/or other aspects and utilities of the present general inventive concept may also achieved by providing photoconductor including a supporter, and a photoconductive member formed on the supporter, the photoconductive member including a charge generating layer comprising including a charge generating material (CGM), a charge transporting layer including a hole transporting material (HTM) comprising a naphthalenetetracarboxylic acid diimide derivative represented by the following Formula (I),

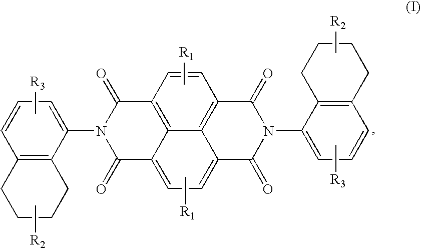

in which, R₁, R₂, and R₃ are each independently selected from the group consisting of a hydrogen atom, a halogen atom, a substituted or unsubstituted C₁ to C₂₀ alkyl group, a substituted or unsubstituted C₁ to C₂₀ alkoxy group, a substituted or unsubstituted C₆ to C₃₀ aryl group, and a substituted or unsubstituted C₇ to C₃₀ aralkyl group.

The foregoing and/or other aspects and utilities of the present general inventive concept may also achieved by providing a photoconductor including a supporter, and a photoconductive member formed on the supporter, the photoconductive member including a charge generating layer comprising including a charge generating material (CGM), a charge transporting layer including a hole transporting material (HTM) including a compound represented by the following Formula (XIII),

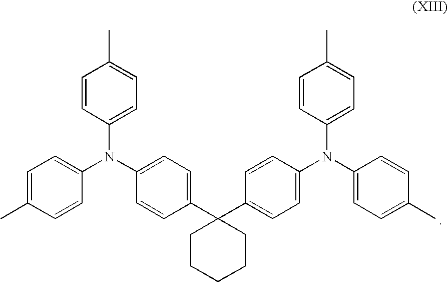

The foregoing and/or other aspects and utilities of the present general inventive concept may also achieved by providing an electrophotographic image forming apparatus including a photoconductor including a supporter, and a photoconductive member formed on the supporter, the photoconductive member including a charge generating layer comprising including a charge generating material (CGM), and a charge transporting layer including a hole transporting material (HTM) comprising a compound represented by the following Formula (XIII),

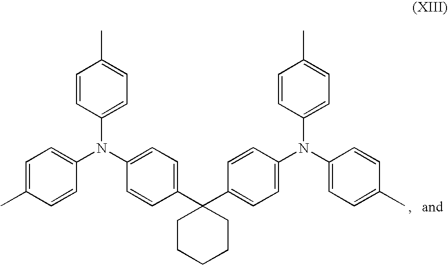

a short-wavelength light source to form an electrostatic latent image on the photoconductor.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic view illustrating an image forming apparatus;

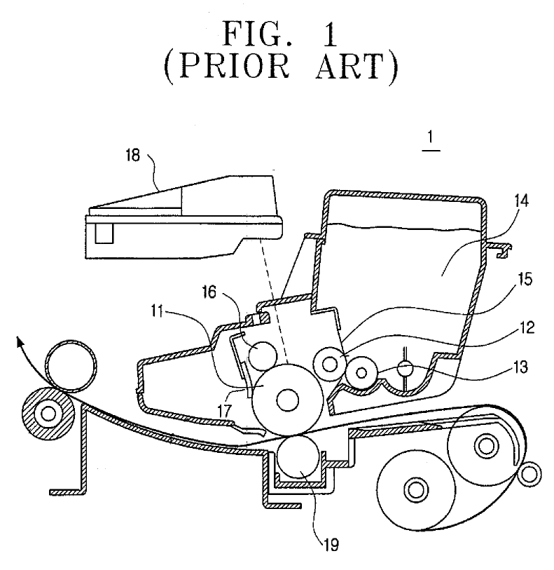

FIG. 2 is a graph illustrating absorbance at each wavelength corresponding to each compound represented by Formulae (II), (i), and (ii); and

FIG. 3 is a graph illustrating absorbance at each wavelength corresponding to each compound represented by Formulae (XI) and (XIII).

Throughout the drawings, the same reference numerals will be understood to refer to the same elements, features, and structures.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

According to an exemplary embodiment of the present general inventive concept, a photoconductor of an electrophotographic image forming apparatus using a short-wavelength light source includes a supporter and a photoconductive layer which is formed on the supporter. The photoconductive layer includes a naphthalenetetracarboxylic acid diimide derivative represented by the following Formula (I),

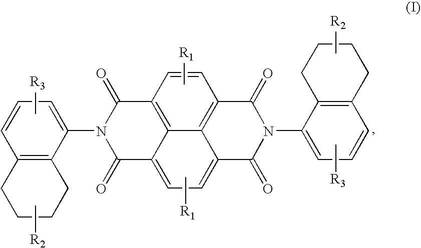

in which, R₁, R₂, and R₃ are each independently selected from the group consisting of a hydrogen atom, a halogen atom, a substituted or unsubstituted C₁ to C₂₀ alkyl group, a substituted or unsubstituted C₁ to C₂₀ alkoxy group, a substituted or unsubstituted C₆ to C₃₀ aryl group, and a substituted or unsubstituted C₇ to C₃₀ aralkyl group.

Examples of the naphthalenetetracarboxylic acid diimide derivative represented by the following Formula (I) may include one of compounds represented by the following Formulae (II) to (VIII),

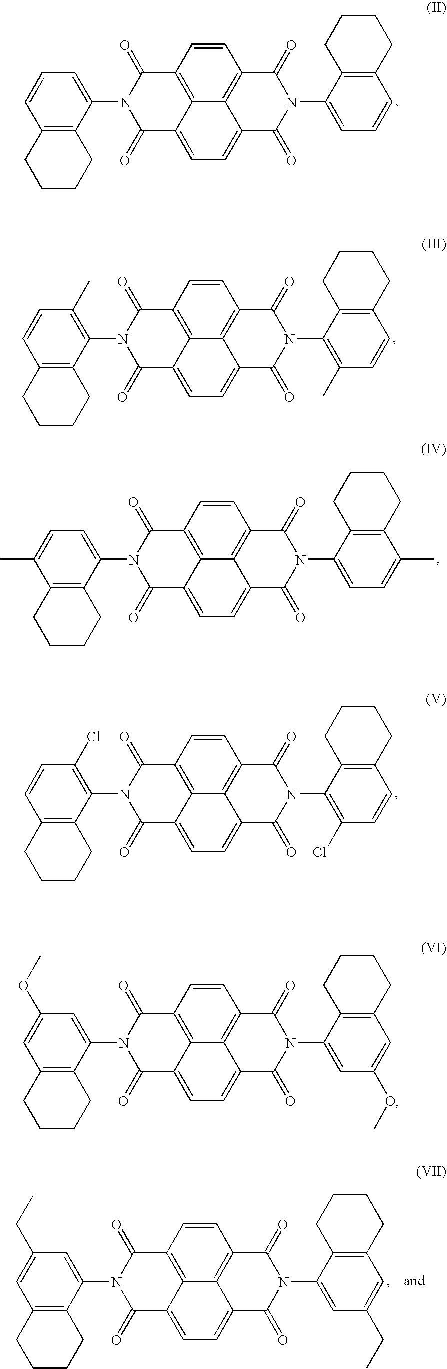

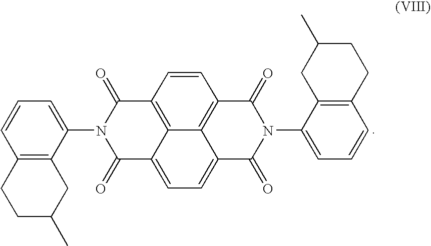

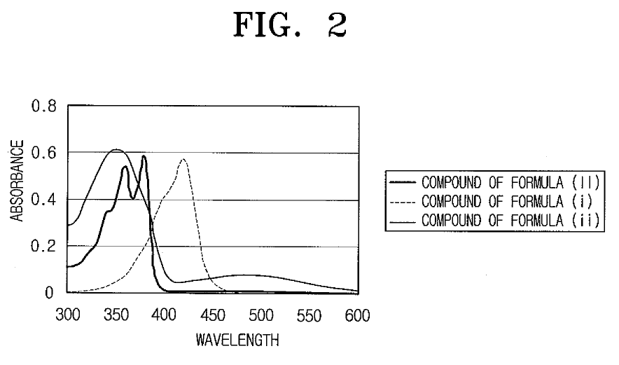

FIG. 2 is a graph illustrating the absorbance of a compound represented by Formula (II). The absorbance of the compound represented by Formula (II) is illustrated with a thick solid line.

The compound of Formula (II) has an absorbance which is reduced to very close to 0 from approximately 400 nm in the wavelength of the light emitted from the light source, and accordingly, it can be found that light is barely absorbed. Therefore, the compound of Formula (II) may be used in the photoconductor of the electrophotographic image forming apparatus using the short-wavelength light source according to the above exemplary embodiment.

Photoconductors of electrophotographic image forming apparatuses are usually divided into laminated-type photoconductors and single-layer type photoconductors. Laminated-type photoconductors include two layers, formed of a charge generating layer including a binder resin and a charge generating material (CGM), and a charge transporting layer including a binder resin and a charge transporting material (mainly, hole transporting material (HTM)). In general, laminated-type photoconductors are used to prepare negative photoconductors.

Single-layer type photoconductors include all the binder resin, CGM, HTM, and an electron transporting material (ETM) within a same layer, and are generally used to prepare positive organic photoconductors.

The compound of Formula (I) according to the exemplary embodiment of the present general inventive concept may be used in either or both of the laminated-type photoconductor and the single-layer type photoconductor.

The compound of Formula (I) above may be used as the ETM in the photoconductor. In other words, the compound of Formula (I) may be included in the charge transporting layer of the laminated-type photoconductor, and may be included together with the CGM within the single layer of the single-layer type photoconductor.

Examples of the ETM, which may be used together with the compound of Formula (I) above may include an electron accepting low-molecular weight compound, such as benzoquinones, cyanoethylenes, cyanoquinodimethanes, fluorenones, xanthones, phenanthraquinones, phthalic acid anhydrides, thiopyrans and diphenoquinones, but are not limited thereto. Additionally, an electron transporting polymer or a pigment with n-type semiconductor characteristics may be used.

The photoconductive layer contained in the above described photoconductor includes the CGM and HTM.

Examples of the CGM may include an organic material such as a phthalocyanine-based pigment, an azo-based pigment, a quinone-based pigment, a perylene-based pigment, an indigo-based pigment, a bisbenzoimidazole-based pigment, a quinacridone-based pigment, an azulenium-based dye, a squarylium-based dye, a pyrylium-based dye, a triarylmethane-based dye, a cyanine-based dye, or the like; and an inorganic material such as amorphous silicon, amorphous selenium, trigonal selenium, tellurium, a selenium-tellurium alloy, cadmium sulfide, antimony sulfide, zinc sulfide, or the like. The CGM used in the photoconductive layer is limited to the above materials, and can be used alone or in combination of two or more.

The CGM may be titanyl oxyphthalocyanine, as represented by the following Formula (IX),

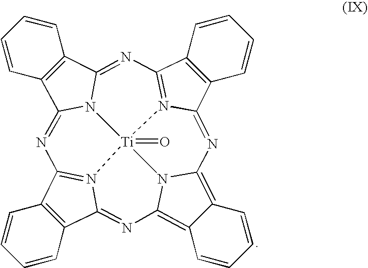

Examples of the HTM may include a nitrogen-containing cyclic compound or a condensed polycyclic compound, such as pyrenes, carbazoles, hydrazones, oxazoles, oxadiazoles, pyrazolines, arylamines, arylmethanes, benzidines, thiazoles, styryls, or the like; and a polymer or a polysilane-based compound having the above substituents in a main chain or a side chain.

The HTM may be a compound represented by the following Formula (X),

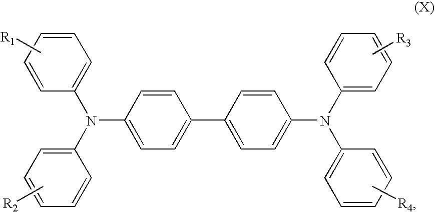

in which, R₁, R₂, R₃, and R₄ are each independently selected from the group consisting of a hydrogen atom, a halogen atom, a substituted or unsubstituted C₁ to C₂₀ alkyl group, a substituted or unsubstituted C₁ to C₂₀ alkoxy group, a substituted or unsubstituted C₆ to C₃₀ aryl group, and a substituted or unsubstituted C₇ to C₃₀ aralkyl group.

It is desirable that the HTM be a compound represented by the following Formula (Xl) taken from Formula (X),

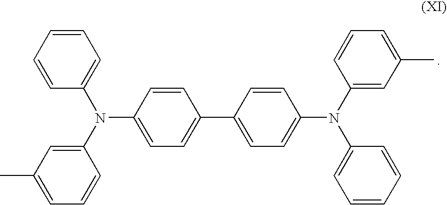

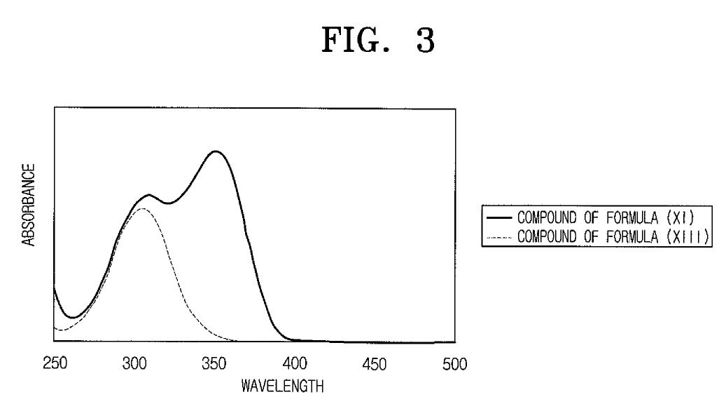

FIG. 3 is a graph illustrating the absorbance of a compound represented by Formula (XI). The absorbance of the compound represented by Formula (XI) is illustrated with a thick solid line.

The compound of Formula (XI) has an absorbance which is reduced to very close to 0 from approximately 400 nm in the wavelength of the light emitted from the light source, and accordingly, it can be found that light is barely absorbed. Therefore, the compound of Formula (XI) may be used in the photoconductor of the electrophotographic image forming apparatus using the short-wavelength light source according to the exemplary embodiment of the present general inventive concept.

Additionally, the HTM may be a compound represented by the following Formula (XII),

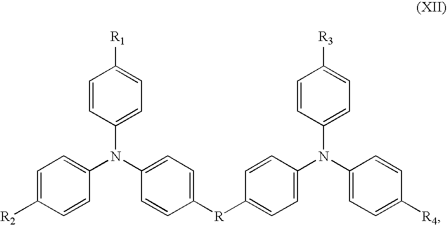

in which, R₁, R₂, R₃, and R₄ are each independently selected from the group consisting of a hydrogen atom, a halogen atom, a substituted or unsubstituted C₁ to C₂₀ cycloalkyl group, a substituted or unsubstituted C₁ to C₂₀ alkyl group, a substituted or unsubstituted C₁ to C₂₀ alkoxy group, a substituted or unsubstituted C₆ to C₃₀ aryl group, and a substituted or unsubstituted C₇ to C₃₀ aralkyl group.

It is desirable that the HTM be a compound represented by the following Formula (XIII) taken from Formula (XII),

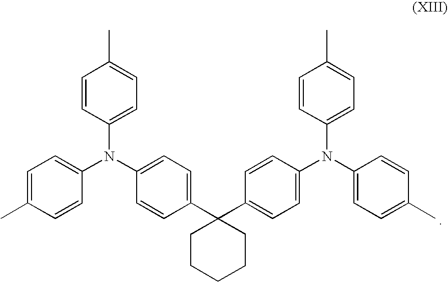

FIG. 3 is a graph illustrating the absorbance of a compound represented by Formula (XIII). The absorbance of the compound represented by Formula (XIII) is illustrated with a thick solid line.

The compound of Formula (XIII) has an absorbance which is reduced to very close to 0 from approximately 350 nm in the wavelength of the light emitted from the light source, and accordingly, it can be found that light is barely absorbed. Therefore, the compound of Formula (XIII) may be used in the photoconductor of an electrophotographic image forming apparatus using the short-wavelength light source according to the exemplary embodiment of the present general inventive concept.

Additionally, according to another exemplary embodiment of the present general inventive concept, an electrophotographic image forming apparatus uses a short-wavelength light source and employs a photoconductor. The photoconductor includes a supporter, and a photoconductive layer which is formed on the supporter. The photoconductive layer may include a naphthalenetetracarboxylic acid diimide derivative represented by the following Formula (I),

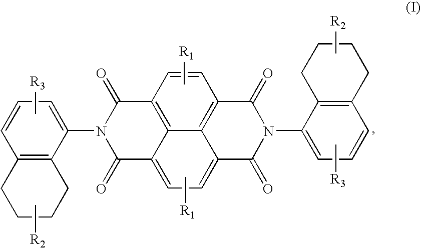

in which, R₁, R₂, and R₃ are each independently selected from the group consisting of a hydrogen atom, a halogen atom, a substituted or unsubstituted C₁ to C₂₀ alkyl group, a substituted or unsubstituted C₁ to C₂₀ alkoxy group, a substituted or unsubstituted C₆ to C₃₀ aryl group, and a substituted or unsubstituted C₇ to C₃₀ aralkyl group.

In the electrophotographic image forming apparatus using the compound of Formula (I) as a photoconductive layer, the light emitted from the light source of a laser scanning device may have a wavelength of approximately 400 nm to approximately 500 nm taking into consideration a resolution.

FIG. 2 illustrates a graph illustrating the absorbance for the compound of Formula (II), as described above. In order to examine the absorbance of the compound of Formula (I) according to the exemplary embodiment of the present general inventive concept, the absorbance of the compound of Formula (II) is measured. The absorbance of the compound of Formula (II) is illustrated with a thick solid line.

The compound of Formula (II) has an absorbance which is approximately 0.6 in a range of 350 nm to 400 nm, but is reduced to very close to 0 from approximately 400 nm, in the wavelength of the light emitted from the light source, and accordingly, it can be found that light is barely absorbed. Therefore, the compound of Formula (II) exhibiting the above absorbance level may be used in the photoconductor which can be exposed to the light emitted from the short-wavelength light source. Thus, a high-resolution image can be formed.

Additionally, in FIG. 2, the absorbances of compounds represented by the following Formulae (i) and (ii) are illustrated with a dotted line and a fine solid line, respectively,

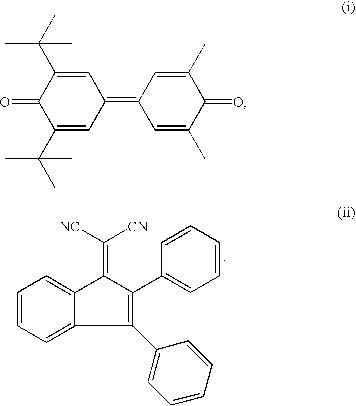

The compounds represented by the above Formulae (i) and (ii) exhibit an absorbance which is higher than 0 at a wavelength of approximately 400 nm or higher. Therefore, it will be difficult to form a high-resolution image, because the above compounds exhibit high absorbance in the short-wavelength light source having a wavelength of approximately 400 nm to approximately 500 nm, to absorb light.

The above compounds of Formulae (i) and (ii) are used in Comparative Examples which are compared to the following Examples.

### EXAMPLE

Hereinafter, in Examples 1 and 2, photoconductors of an electrophotographic image forming apparatus according to exemplary embodiments of the present general inventive concept, were prepared using a photoconductive layer including a compound represented by Formula (I). In Comparative Examples 1 and 2, photoconductors were prepared using compounds represented by Formulae (i) and (ii), which are conventional electron transporting materials (ETMs), instead of the compound represented by Formula (I).

### Example 1

A compound represented by Formula (II) (ETM, 26 parts by weight), a compound represented by Formula (IX) (y type titanyl oxyphthalocyanine, charge generating material (CGM), 3 parts by weight), a compound represented by Formula (XIII) (hole transporting material (HTM), 26 parts by weight), a compound represented by Formula (XIV) (binder resin, 45 parts by weight), and methylene chloride (420 parts by weight) and 1,1,2-trichloroethane (105 parts by weight) as a solvent, were sand-milled for 2 hours, and then dispersed using ultrasonic waves. The obtained solution was coated on an anodized aluminum drum as a supporter, and then dried at 110° C. for 1 hour to obtain a photoconductive drum having a thickness of approximately 15 mm to approximately 16 mm. Formula (XIV) is as follows,

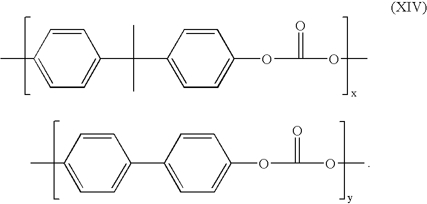

### Example 2

A photoconductive drum was prepared in the same manner as in Example 1, except that the compound represented by Formula (XI) was used as the HTM.

### Comparative Example 1

A photoconductive drum was prepared in the same manner as in Example 1, except that the compound represented by Formula (i) was used as the ETM. Formula (i) is given by,

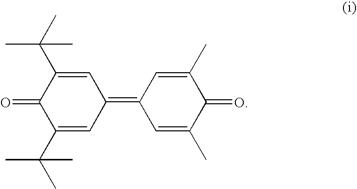

### Comparative Example 2

A photoconductive drum was prepared in the same manner as in Example 1, except that the compound represented by Formula (ii) was used as the ETM. Formula (ii) is given by,

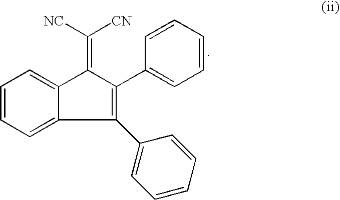

### Evaluation

Electrophotographic characteristics of each photoconductor obtained in Examples and Comparative Examples were measured using a drum photoconductor evaluation apparatus (Cynthia_{—}92KSS).

Measurement was performed in the following conditions: a light source adopted a light emitting diode (LED) with a wavelength of 430 nm. A voltage was supplied so that a charge potential Vo was 600V, a surface potential value after exposure was recorded, and a relationship between energy and the surface potential was measured.

TABLE 1

| | Electron | Hole | | | |
|---|---|---|---|---|---|
| | Transporting | Transporting | EP performance | | |
| | Material | Material | E½ | E200 | E100 |
| Example 1 | Compound | Compound | 0.45 | 1.02 | 2.34 |
| | of Formula (II) | of Formula (XIII) | | | |
| Example 2 | Compound | Compound | 0.46 | 0.89 | 1.69 |
| | of Formula (II) | of Formula (XI) | | | |
| Comparative | Compound | Compound | 1.98 | 3.54 | — |
| Example 1 | of Formula (i) | of Formula (XIII) | | | |
| Comparative | Compound | Compound | 1.32 | 2.65 | — |
| Example 2 | of Formula (ii) | of Formula (XIII) | | | |

E½ (μJ/cm²) is a light energy consumed until sensitivity and the surface potential dropped to ½.
E100 (μJ/cm²) is a light energy consumed until the surface potential reached 100 V.
E200 (μJ/cm²) is a light energy consumed until the surface potential reached 200 V.

As illustrated in Table 1, the photoconductors of Examples 1 and 2 had low E1/2, E100, and E200 values compared to the photoconductors of Comparative Examples 1 and 2.

This is because the compound of Formula (II) in Examples 1 and 2 had a low absorbance, and the light of 430 nm freely reached the CGM to generate an electric charge effectively. Accordingly, the sensitivity was increased, and the E100 and E200 values were reduced.

In Comparative Examples 1 and 2, it is assumed that since the compounds of Formulae (i) and (ii) had very high absorbance (referring to FIG. 2), most of the light with a wavelength of 430 nm was absorbed, and the light was not transported to the CGM accordingly. Therefore, an electric charge was not effectively generated by the CGM, and the photoconductors had poor EP performance.

As described above, according to exemplary embodiments of the present general inventive concept, a photoconductor is prepared using a compound exhibiting a relatively low absorbance of a short-wavelength light in a predetermined waveband, and can be effectively used in an electrophotographic image forming apparatus using the light emitted from the short-wavelength light source.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A photoconductor of an electrophotographic image forming apparatus using a short-wavelength light source, the photoconductor comprising:
a supporter; and
a photoconductive layer, which is formed on the supporter,
wherein the photoconductive layer comprises a naphthalenetetracarboxylic acid diimide derivative represented by the following Formula (I), 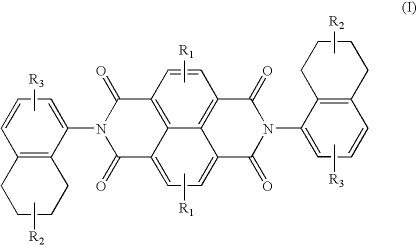
in which, R₁, R₂, and R₃ are each independently selected from the group consisting of a hydrogen atom, a halogen atom, a substituted or unsubstituted C₁ to C₂₀ alkyl group, a substituted or unsubstituted C₁ to C₂₀ alkoxy group, a substituted or unsubstituted C₆ to C₃₀ aryl group, and a substituted or unsubstituted C₇ to C₃₀ aralkyl group.

2. The photoconductor as claimed in claim 1, wherein the light of the short-wavelength light source has a wavelength of approximately 400 nm to approximately 500 nm.

3. The photoconductor as claimed in claim 1, wherein the naphthalenetetracarboxylic acid diimide derivative is any one of compounds represented by the following Formulae (II) to (VIII),

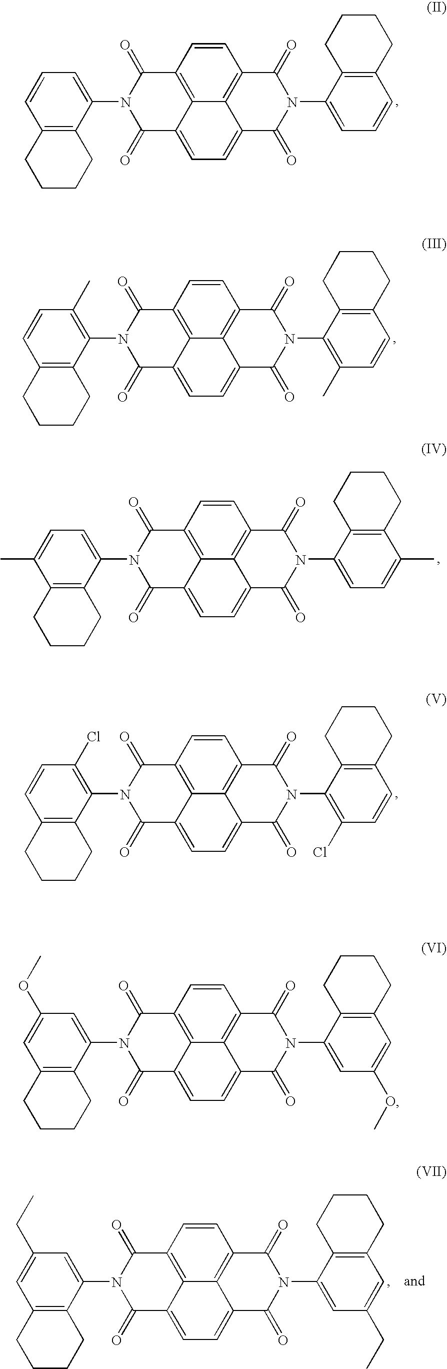

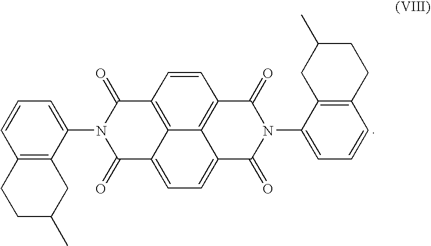

4. The photoconductor as claimed in claim 1, wherein the photoconductive layer further comprises a charge generating material and a hole transporting material.

5. The photoconductor as claimed in claim 4, wherein the charge generating material is titanyl oxyphthalocyanine, as represented by the following Formula (IX),

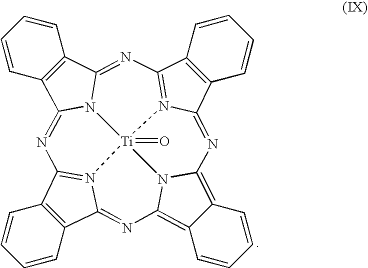

6. The photoconductor as claimed in claim 4, wherein the hole transporting material is a compound represented by the following Formula (X), 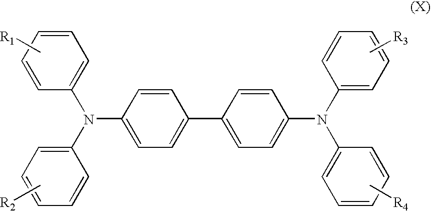
in which, R₁, R₂, R₃, and R₄ are each independently selected from the group consisting of a hydrogen atom, a halogen atom, a substituted or unsubstituted C₁ to C₂₀ alkyl group, a substituted or unsubstituted C₁ to C₂₀ alkoxy group, a substituted or unsubstituted C₆ to C₃₀ aryl group, and a substituted or unsubstituted C₇ to C₃₀ aralkyl group.

7. The photoconductor as claimed in claim 6, wherein the hole transporting material is a compound represented by the following Formula (Xl),

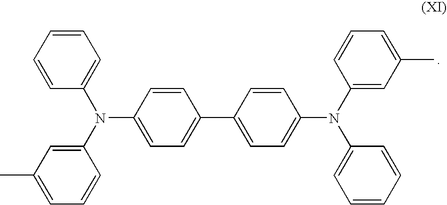

8. The photoconductor as claimed in claim 4, wherein the hole transporting material is a compound represented by the following Formula (XII), 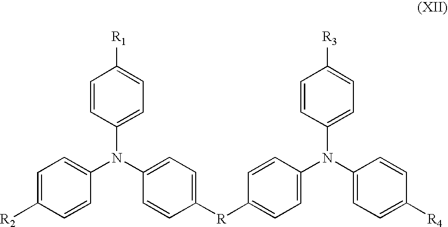
in which, R₁, R₂, R₃, and R₄ are each independently selected from the group consisting of a hydrogen atom, a halogen atom, a substituted or unsubstituted C₁ to C₂₀ cycloalkyl group, a substituted or unsubstituted C₁ to C₂₀ alkyl group, a substituted or unsubstituted C₁ to C₂₀ alkoxy group, a substituted or unsubstituted C₆ to C₃₀ aryl group, and a substituted or unsubstituted C₇ to C₃₀ aralkyl group.

9. The photoconductor as claimed in claim 8, wherein the hole transporting material is a compound represented by the following Formula (XIII),

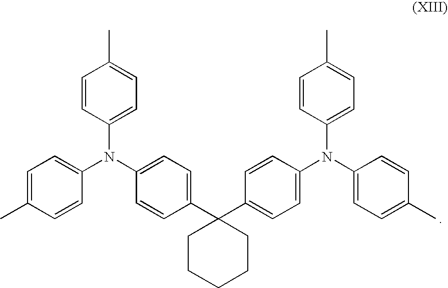

10. An electrophotographic image forming apparatus using a short-wavelength light source and employing a photoconductor, the photoconductor comprising:
a supporter; and
a photoconductive layer which is formed on the supporter and comprises a naphthalenetetracarboxylic acid diimide derivative represented by the following Formula (I), 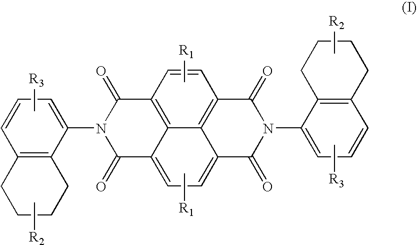
in which, R₁, R₂, and R₃ are each independently selected from the group consisting of a hydrogen atom, a halogen atom, a substituted or unsubstituted C₁ to C₂₀ alkyl group, a substituted or unsubstituted C₁ to C₂₀ alkoxy group, a substituted or unsubstituted C₆ to C₃₀ aryl group, and a substituted or unsubstituted C₇ to C₃₀ aralkyl group.

11. The apparatus as claimed in claim 10, wherein the light of the short-wavelength light source has a wavelength of approximately 400 nm to approximately 500 nm.

12. An electrophotographic image forming apparatus comprising:
a photoconductor comprising:
a supporter, and
a photoconductive layer formed on the supporter,
wherein the photoconductive layer comprises a naphthalenetetracarboxylic acid diimide derivative represented by the following Formula (I), 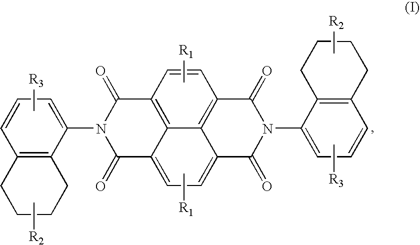
in which, R₁, R₂, and R₃ are each independently selected from the group consisting of a hydrogen atom, a halogen atom, a substituted or unsubstituted C₁ to C₂₀ alkyl group, a substituted or unsubstituted C₁ to C₂₀ alkoxy group, a substituted or unsubstituted C₆ to C₃₀ aryl group, and a substituted or unsubstituted C₇ to C₃₀ aralkyl group; and
a short-wavelength light source to form an electrostatic latent image on the photoconductor,
wherein the short-wavelength light source has a wavelength of approximately 400 nm to approximately 500 nm.

13. A photoconductor comprising:
a supporter, and
a photoconductive layer formed on the supporter, the photoconductive layer comprising:
binder resin;
a charge generating material (CGM);
a hole transporting material (HTM); and
an electron transporting material (ETM) comprising a naphthalenetetracarboxylic acid diimide derivative represented by the following Formula (I), 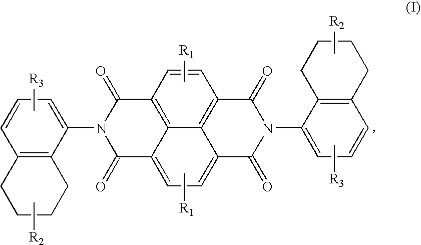
in which, R₁, R₂, and R₃ are each independently selected from the group consisting of a hydrogen atom, a halogen atom, a substituted or unsubstituted C₁ to C₂₀ alkyl group, a substituted or unsubstituted C₁ to C₂₀ alkoxy group, a substituted or unsubstituted C₆ to C₃₀ aryl group, and a substituted or unsubstituted C₇ to C₃₀ aralkyl group.

14. A photoconductor comprising:
a supporter, and
a photoconductive member formed on the supporter, the photoconductive member comprising:
a charge generating layer comprising including a charge generating material (CGM);
a charge transporting layer including a hole transporting material (HTM) comprising a naphthalenetetracarboxylic acid diimide derivative represented by the following Formula (I), 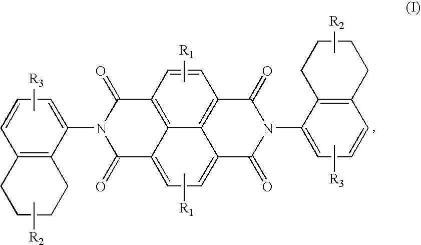
in which, R₁, R₂, and R₃ are each independently selected from the group consisting of a hydrogen atom, a halogen atom, a substituted or unsubstituted C₁ to C₂₀ alkyl group, a substituted or unsubstituted C₁ to C₂₀ alkoxy group, a substituted or unsubstituted C₆ to C₃₀ aryl group, and a substituted or unsubstituted C₇ to C₃₀ aralkyl group.

15. A photoconductor comprising:
a supporter, and
a photoconductive member formed on the supporter, the photoconductive member comprising:
a charge generating layer comprising including a charge generating material (CGM);
a charge transporting layer including a hole transporting material (HTM) comprising a compound represented by the following Formula (XIII),

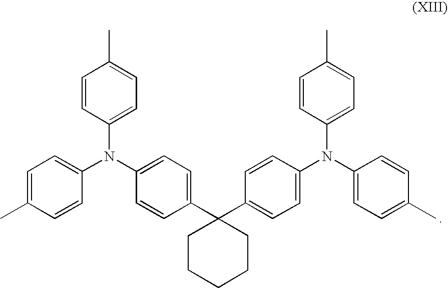

16. An electrophotographic image forming apparatus comprising:
a photoconductor comprising:
a supporter, and
a photoconductive member formed on the supporter, the photoconductive member comprising:
a charge generating layer comprising including a charge generating material (CGM), and
a charge transporting layer including a hole transporting material (HTM) comprising a compound represented by the following Formula (XIII), 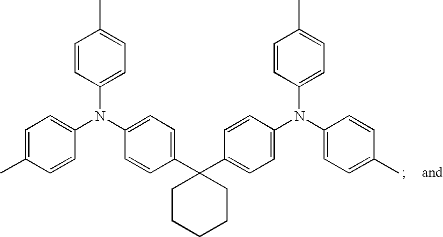
a short-wavelength light source to form an electrostatic latent image on the photoconductor.

17. The apparatus of claim 16, wherein the short-wavelength light source has a wavelength of approximately 350 nm to approximately 500 nm.
